(19) United States
(12) Patent Application Publication
(10) Pub. No.: US 2026/0336141 A1
(43) Pub. Date: Oct. 29, 2026

(54) KITCHEN KNIFE AND METHOD OF MANUFACTURING KITCHEN KNIFE

(71) Applicant: KAI R&D CENTER CO., LTD., Seki-shi (JP)

(72) Inventor: Tommie R. Lucas, JR., Tualatin, OR (US)

(21) Appl. No.: 19/732,897

(22) Filed: Jul. 7, 2026

Related U.S. Application Data
(62) Division of application No. 18/461,924, filed on Sep. 6, 2023.

(51) Int. Cl. B26B 9/00; B26B 3/00

(52) U.S. Cl. CPC B26B 9/00; B26B 3/00

(57) ABSTRACT

A kitchen knife is provided. The kitchen knife may include a blade with a cutting edge at an end surface on one side and a reinforcing part provided in such a manner as to extend along a spine that is an end surface of the blade on the other side, and reinforcing the blade in a thickness direction. The reinforcing part is made of a metallic member and joined to the spine.

### CROSS REFERENCE TO RELATED APPLICATIONS

This application is a divisional of U.S. App. No. 18/461,924, filed Sep. 6, 2023, which is incorporated herein by reference in entirety.

### FIELD

The present disclosure generally relates to a kitchen knife and the like.

### BACKGROUND

### DESCRIPTION OF RELATED ART

Kitchen knives conventionally used in cooking food have a variety of shapes conforming to their purposes of use. For example, to provide a kitchen knife usable for cutting even a soft food material continuously without crushing the food material, Patent Document 1 discloses a configuration for a kitchen knife for cooking including a blade with a spine part and a blade part, and a handle where the blade part has a reduced thickness from the center to the top of the blade, and the blade has curved sections on opposite lateral sides of the blade part at an upper position thereof. Patent Document 2 discloses a kitchen knife including a spine provided with a cover.

Patent Document 1: Japanese Patent Application Publication No. 2005-198972

Patent Document 2: Japanese Utility Model Application Publication No. Sho 49-144548

### SUMMARY

While a kitchen knife used in a domestic kitchen having a relatively greater blade length has a certain amount of weight, a kitchen knife having a reduced weight is required in some cases. However, thinning a blade for reducing the weight of a kitchen knife easily causes bending of the kitchen knife. This may reduce usability of the kitchen knife or make it difficult to cut food materials with the kitchen knife.

In Japan, food materials are cut using the weight of a kitchen knife in many cases. In response to this, the kitchen knife may have a configuration with a heavy blade and a light handle. In western countries, however, some people cut food materials by pushing or pulling kitchen knives. In this case, a kitchen knife with a light blade is easier to use. High usability is achieved particularly if the weight of an entire kitchen knife is reduced and the barycenter is present around the center of the kitchen knife (corresponding to a center area among those defined by dividing an entire length of the kitchen knife into equal thirds, for example).

The present disclosure is intended to provide a kitchen knife that suppresses bending and easy to use in cutting food materials even if the kitchen knife includes a thin blade.

A kitchen knife according to some embodiments of the present disclosure comprises: a blade with a cutting edge at an end surface on one side; and a reinforcing part provided in such a manner as to extend along a spine that is an end surface of the blade on the other side, and reinforcing the blade in a thickness direction. The reinforcing part is made of a metallic member and joined to the spine.

According to this kitchen knife, as the spine of the blade is reinforced using the reinforcing part made of the metallic member, it is possible to realize a configuration resistant to bending and easy to use in cutting food materials even if the blade is thin. Furthermore, as the spine of the blade is thickened, food materials can be separated easily during cutting of the food materials with the kitchen knife.

In Japan, food materials are cut using the weight of a kitchen knife in many cases. In response to this, the kitchen knife may have a configuration with a heavy blade and a light handle. In western countries, however, some people cut food materials by pushing or pulling kitchen knives. In this case, as a kitchen knife with a light blade is easier to use, there is a need for a kitchen knife with a thin and light blade like the kitchen knife of the present disclosure.

Moreover, reducing the weight of an entire kitchen knife and locating the barycenter around the center of the kitchen knife (corresponding to a center area among those defined by dividing an entire length of the kitchen knife into equal thirds, for example) is preferable as it achieves high usability.

In the above-described kitchen knife, it is preferable that the metallic member be different from metal forming the blade.

According to this kitchen knife, a metal different from the metal forming the blade and suitable for suppressing bending of the blade can be used as a material for the reinforcing part. More specifically, the blade can be made using a metal having high hardness and suitable for the blade, and the reinforcing part can be made using a metal having lower hardness than the blade. This makes it possible to provide a kitchen knife achieving a balance between function and cost.

In the above-described kitchen knife, the reinforcing part may include a fitting groove fitted to the spine and formed in such a manner as to extend along the spine.

According to this kitchen knife, a tube-like member or a member having a U-shaped section can used as the reinforcing part, for example. This allows the reinforcing part to be joined to the blade through a relatively simple process.

In the above-described kitchen knife, the reinforcing part may be made of a metallic member welded to the spine in such a manner as to extend along the spine.

According to this kitchen knife, it is possible to realize a configuration of the reinforcing part through welding of the metal usable for suppressing bending of the blade effectively.

In the above-described kitchen knife, the reinforcing part may be provided in such a manner as to extend continuously from the spine to a grasped part to be grasped by a user.

According to this kitchen knife, it is possible to realize a configuration that can suppress not only bending of the blade but also bending of the grasped part. Thus, this configuration achieves higher usability and is easier to use in cutting food materials.

In the above-described kitchen knife, the reinforcing part may be provided in such a manner as to extend along an end surface of the grasped part and to extend continuously to a heel that is an end surface of the blade adjacent to the grasped part.

According to this kitchen knife, it is possible to realize a configuration that can suppress bending of the blade in a direction from the cutting edge toward the spine of the blade and can suppress bending of the grasped part more effectively.

In the above-described kitchen knife, the reinforcing part may be provided in such a manner as to extend further along an end surface of a grasped part on the one side to be grasped by a user.

According to this kitchen knife, it is possible to realize a configuration that can suppress bending of the grasped part more effectively.

In the above-described kitchen knife, it is preferable that the blade have a blade length of equal to or greater than 100 mm.

According to this kitchen knife, even if the kitchen knife has a relatively long blade length such as a butcher knife or a multi-purpose knife, bending of the blade is still suppressed effectively to allow meat and vegetables to be cut easily.

In the above-described kitchen knife, it is preferable that the blade be made of metal having a thickness of equal to or less than 2.5 mm.

According to this kitchen knife, in a kitchen knife having a shape with a thin blade and subjected to bending easily, bending of the blade can be suppressed effectively. Furthermore, the thinness of the blade reduces resistance in cutting food materials. Moreover, in comparison to a kitchen knife including a thick blade, the material forming the kitchen knife can be reduced to allow reduction in material cost. Additionally, the amount of polishing of the blade can be reduced during sharpening, allowing reduction in processing cost.

In the above-described kitchen knife, it is preferable that the reinforcing part have a thickness three times or more of the thickness of the blade at the thickest position.

According to this kitchen knife, it is possible to realize a configuration that can suppress bending of the blade more effectively.

In the above-described kitchen knife, it is preferable that the blade have a weight of equal to or less than 200 g.

According to this kitchen knife, in a kitchen knife including a light blade that bends easily, bending of the blade can be suppressed effectively.

A kitchen knife according to some embodiments of the present disclosure comprises: a blade with a cutting edge at an end surface on one side; and a reinforcing part provided in such a manner as to extend along a spine that is an end surface of the blade on the other side, and reinforcing the blade in a thickness direction. The reinforcing part is formed by folding over the blade at the spine.

According to this kitchen knife, as the blade is reinforced by the reinforcing part formed by folding over the blade at the spine of the blade, it is possible to realize a configuration resistant to bending and easy to use in cutting food materials even if the blade is thin.

In the above-described kitchen knife, the reinforcing part is provided in such a manner as to extend further along an end surface of a grasped part on the one side to be grasped by a user.

According to this kitchen knife, it is possible to realize a configuration that can suppress bending of the grasped part effectively in addition to bending of the blade.

A method of manufacturing a kitchen knife according to some embodiments of the present disclosure comprises: a step of clamping a blade with a cutting edge at an end surface on one side with a clamping member in such a manner as to cause an end portion on a spine side opposite to the cutting edge of the blade to protrude; and a step of processing the end-portion on the spine side into a reinforcing part having a thickness relative to the other part of the blade by pressing an end surface on the spine side while moving a pressing member in a longitudinal direction of the blade.

According to the present disclosure, it is possible to provide a kitchen knife resistant to bending and easy to use in cutting food materials.

### BRIEF DESCRIPTION OF DRAWINGS

FIG. 1 is an exploded perspective view of a kitchen knife according to a first embodiment.

FIG. 2 is a front view of the kitchen knife according to the first embodiment.

FIG. 3 is a top view of the kitchen knife according to the first embodiment.

FIG. 4 is a perspective view of a kitchen knife according to a second embodiment.

FIG. 5 is a sectional view of the kitchen knife according to the second embodiment.

FIG. 6 is a perspective view of a kitchen knife according to a third embodiment.

FIG. 7 is an exploded perspective view of a kitchen knife according to a fourth embodiment.

FIG. 8 is a front view of the kitchen knife according to the fourth embodiment.

FIG. 9 is an exploded perspective view of a kitchen knife according to a fifth embodiment.

FIG. 10 is a perspective view of a kitchen knife according to a sixth embodiment.

FIG. 11 is a sectional view of the kitchen knife according to the sixth embodiment.

FIG. 12 is a perspective view of a processing unit for a kitchen knife according to a seventh embodiment.

FIG. 13 is a perspective view of the processing unit for the kitchen knife according to the seventh embodiment.

FIG. 14 is a front view of the processing unit for the kitchen knife according to the seventh embodiment.

FIG. 15A is a sectional view of the processing unit for the kitchen knife according to the seventh embodiment.

FIG. 15B is an enlarged view of an area G in FIG. 15A.

FIG. 16 is a perspective view of the kitchen knife before processing according to the seventh embodiment.

FIG. 17 is a perspective view of the kitchen knife after the processing according to the seventh embodiment.

FIG. 18 is a flowchart showing a method of processing the kitchen knife according to the seventh embodiment.

### DETAILED DESCRIPTION

The configuration with a reinforcing part provided in such a manner as to extend along the spine of a blade forms one of features of a kitchen knife according to some embodiments of the present disclosure.

Embodiments of the kitchen knife according to the present disclosure will be described below in detail by referring to the drawings. The embodiments and examples described below are merely examples of the present disclosure and are not intended to limit interpretation of the technical scope of the present disclosure. Constituting elements in the drawings equal or corresponding to each other are given the same sign or similar signs, and description overlap between such elements may be omitted.

### First Embodiment

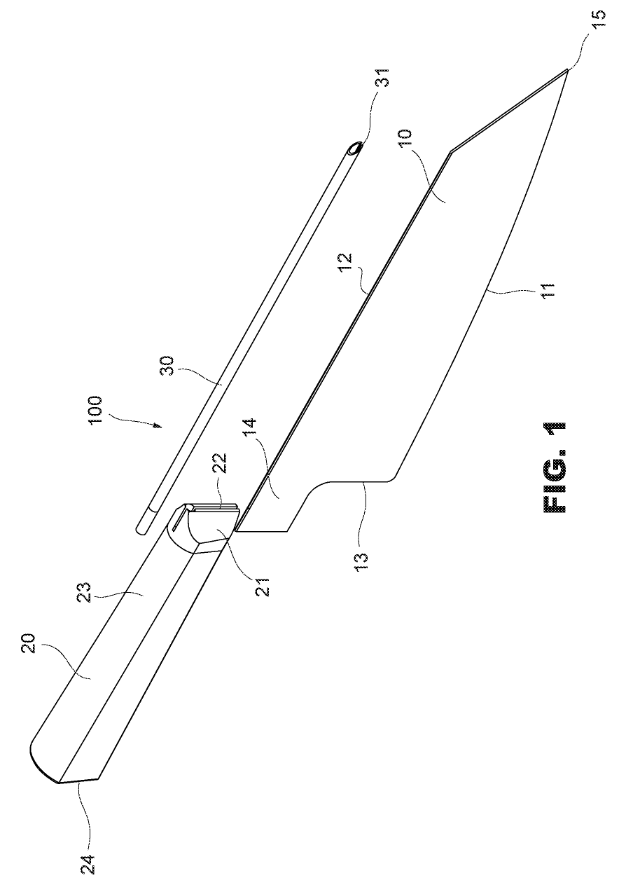

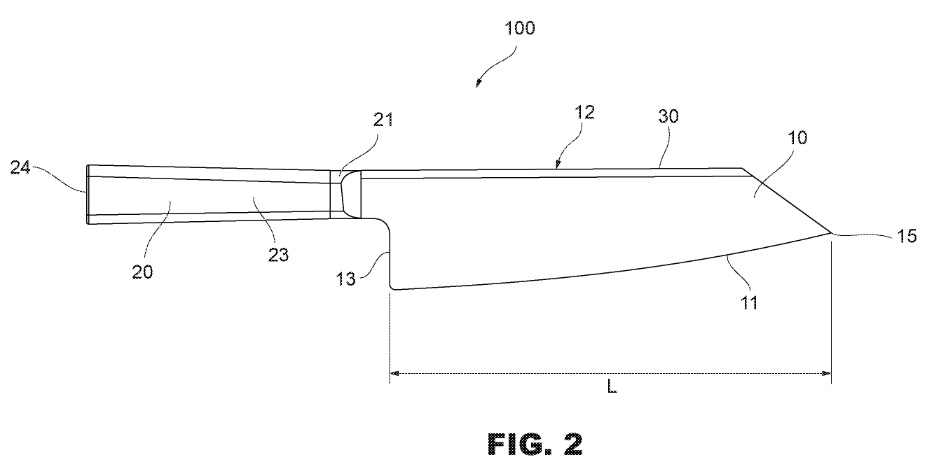

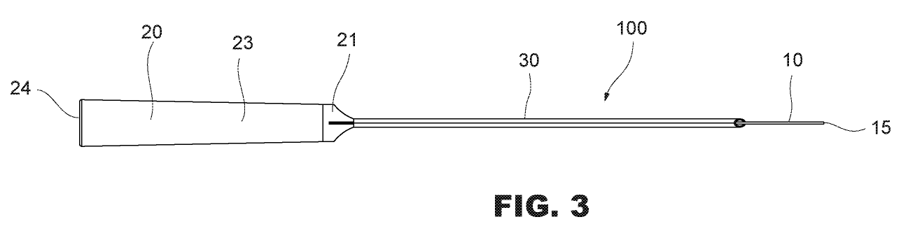

FIGS. 1 to 3 show a kitchen knife 100 according to a first embodiment. FIG. 1 is an exploded perspective view. FIG. 2 is a front view. FIG. 3 is a top view. For the convenience of description, the spine side and the cutting edge side of a kitchen knife including the kitchen knife 100 shown in the drawings attached to the present specification may be called the upper side and the lower side respectively.

As shown in FIGS. 1 to 3, the kitchen knife 100 has a configuration including a blade 10, a handle 20, and a reinforcing part 30. The handle 20 is an example of a “grasped part” of the present disclosure.

The blade 10 is made of metal such as stainless steel, for example, and is polished in such a manner as to sharpen a cutting edge 11 on the lower side. The blade 10 includes a spine 12 on the upper side opposite to the lower side in the presence of the cutting edge 11. As shown in FIGS. 1 to 3, the blade 10 includes a heel 13 at an end surface on the lower side adjacent to the handle 20, a tang 14 on the upper side of the heel 13, and a point 15 at the tip of the cutting edge 11. It is sufficient for the cutting edge 11 to be polished during use and is not always required to be polished sharply on the market. The blade 10 may be made of a material with several types of stacked metals. Preferably, the blade 10 has hardness of equal to or greater than 54 HRC and equal to or less than 66 HRC, more preferably, about 60 HRC.

As shown in FIG. 2, a distance from the heel 13 to the point 15 in a plan view of the blade 10 is called a blade length L. The blade 10 of the present embodiment has the blade length L of 216 mm, a thickness of 1.0 mm at a thickest position, and a weight of 100 g. By setting the blade 10 at a blade length of equal to or greater than 100 mm, more preferably, equal to or greater than 150 mm and equal to or less than 300 mm, even more preferably, equal to or greater than 180 mm and equal to or less than 240 mm, a thickness of equal to or less than 2.5 mm, more preferably, equal to or greater than 0.1 mm and equal to or less than 2.5 mm, more preferably, equal to or greater than 0.5 mm and equal to or less than 1.0 mm, and a weight of equal to or greater than 10 g and equal to or less than 400 g, more preferably, equal to or greater than 10 g and equal to or less than 200 g, it becomes possible to provide the kitchen knife 100 with lightness in weight and high usability.

The reinforcing part 30 for reinforcing the blade 10 in a thickness direction is provided at the spine 12 of the blade 10 in such a manner as to extend along the spine 12. While the spine 12 of the kitchen knife 100 of the present embodiment extends linearly, the spine 12 may be curved.

The reinforcing part 30 is a tube-like member having an annular shape from which a portion corresponding to a fitting groove 31 is removed, and has a shape opened at the portion corresponding to the fitting groove 31 fitted to the spine 12 of the blade 10. The section of the reinforcing part 30 has an annular shape of an outer diameter of 4.0 mm and an inner diameter of 2.0 mm, for example.

The reinforcing part 30 is joined to the blade 10 by welding around a location where the spine 12 and the reinforcing part 30 abut on each other while the spine 12 is held in the fitting groove 31. For the welding, an existing method such as laser welding or brazing is applicable. While the reinforcing part 30 of the present embodiment is configured to be joined to the spine 12 by welding, it may alternatively be configured to hold the spine 12 while pressing the spine 12.

The reinforcing part 30 reinforces the blade 10 in the thickness direction to suppress thickness-direction bending of the blade 10 in a longitudinal direction. Specifically, to reinforce the blade 10 and make the blade 10 resistant to bending, the reinforcing part 30 is made of a metallic material resistant to bending. Generally, to fulfill the function of cutting a cooking target, a particularly hard material is used for the blade 10. Meanwhile, a material for the reinforcing part 30 is not required to be as hard as the material for the blade 10 but is preferably metal of low hardness easier to process than the material for the blade 10. For this reason, the reinforcing part 30 is made of metal different from the metal forming the blade 10. As described above, the metal used for the reinforcing part 30 is less expensive than the metal for the blade 10, thereby providing the kitchen knife with a sufficient function even at relatively low cost. In another case, the reinforcing part 30 may be made of the same metal as the blade 10.

As an example, by using a multilayered material formed by stacking several types of metals for the blade 10 and performing process of forming a pattern on a surface of the blade 10, it becomes possible to provide an attractive appearance to the blade 10. In this case, as the reinforcing part 30 is not as notable as the blade 10, the reinforcing part 30 may be made of metal different from that for the blade 10 without using a multilayered material. This configuration makes it possible to provide the kitchen knife achieving balance between manufacturing cost and function.

Preferably, the reinforcing part 30 has a thickness of equal to or greater than 3.0 mm, which is three times the thickness of the blade 10. Using the reinforcing part 30 of such a thickness makes it possible to suppress bending of the blade 10 effectively.

As given as examples in other embodiments, the reinforcing part 30 is not limited to the shape that is described in the present embodiment but may have another configuration that can suppress thickness-direction bending of the blade 10 in the longitudinal direction.

The handle 20 includes a handle body 23, a bolster 21, and an end cap 24. The bolster 21 is made of metal such as stainless steel and has a connection groove 22 formed into a groove shape. The tang 14 of the blade 10 is inserted into the connection groove 22 and then welded, thereby connecting the blade 10 and the handle 20 to each other. As an example, the handle body 23 is formed into a hollow shape (tube-like shape) using carbon fiber. Alternatively, the handle body 23 may be made of wood or resin and is not always required to have a hollow shape. The end cap 24 is attached as a cap for closing an opening formed at a rear end of the hollow handle body 23. The end cap 24 is made of a metal such as titanium. However, the end cap 24 may be made of another material. The handle 20 is grasped by a user during use.

The handle 20 is not always required to include the bolster 21 and the end cap 24 but may have a configuration without one or both of them. If the handle 20 has a configuration without the bolster 21, the handle body 23 is connected directly to the blade 10.

The kitchen knife 100 described above reinforces the spine 12 of the blade 10 using the reinforcing part 30 made of metal. This realizes a configuration resistant to bending and easy to use in cutting food materials despite lightness in weight achieved by using the thin blade 10.

### Second Embodiment

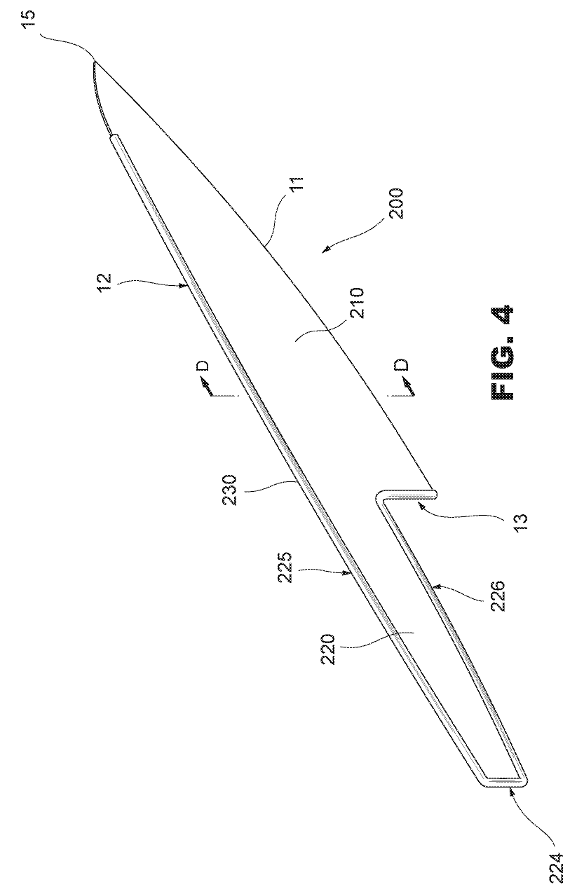

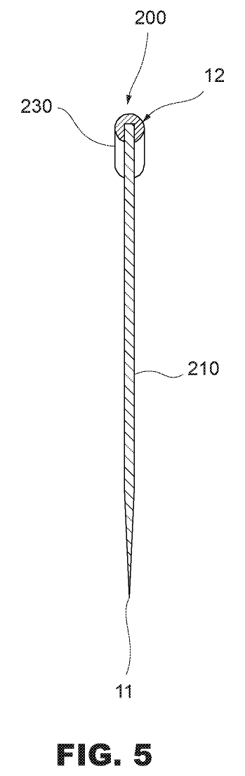

FIGS. 4 and 5 show a kitchen knife 200 according to a second embodiment. FIG. 4 is a perspective view. FIG. 5 is a sectional view taken along the position D-D in FIG. 4. In the present embodiment, the parts different from that of the first embodiment will be described mainly and description of a part corresponding to that of the first embodiment may be omitted.

As shown in FIG. 4, the kitchen knife 200 has a configuration including a blade 210, a handle 220, and a reinforcing part 230. The blade 210 and the handle 220 are formed integrally with each other and made of the same metal. However, the blade 210 and the handle 220 may be made of different metals. The handle 220 is an example of the “grasped part” of the present disclosure.

Like the blade 10 of the first embodiment, the blade 210 and the handle 220 are made of metal such as stainless steel. The handle 220 is formed into a plate-like shape. The blade 210 has the same hardness, blade length, and thickness as the blade 10 of the first embodiment. While the blade 210 has the same weight as the blade 10 of the first embodiment, the weight of the unit including the blade 210 and the handle 220 is greater than that of the blade 10.

The handle 220 has an end surface on the upper side called a handle upper end surface 225, an end surface on the lower side called a handle lower end surface 226, and an end surface on the opposite side to the blade 210 called a handle rear end surface 224. The handle upper end surface 225 is a surface continuous from the spine 12 of the blade 210. As shown in the drawing, a continuously connected shape is formed from the handle upper end surface 225 to the heel 13 through the handle rear end surface 224 and the handle lower end surface 226.

The reinforcing part 230 for reinforcing the blade 210 and the handle 220 in the thickness direction is provided in such a manner as to extend continuously along the spine 12, the handle upper end surface 225, the handle rear end surface 224, the handle lower end surface 226, and the heel 13.

As shown in the sectional view of FIG. 5, the reinforcing part 230 is a member having a U-shaped section, and has a shape opened at a portion corresponding to a fitting groove fitted to a joint including the spine 12 of the blade 210. In comparison to the reinforcing part 30 of the first embodiment, the section of the reinforcing part 230 does not have an annular shape but has a shape defined by squeezing an annular ring.

The reinforcing part 230 is joined to the blade 210 and the handle 220 by performing welding such as laser welding around a place where the reinforcing part 230 abut on the spine 12, the handle upper end surface 225, the handle rear end surface 224, the handle lower end surface 226, and the heel 13 while these parts are held in the fitting groove.

The reinforcing part 230 reinforces the blade 210 in the thickness direction like the reinforcing part 30 of the first embodiment, and further reinforces the handle 220 in the thickness direction. By doing so, the reinforcing part 230 suppresses thickness-direction bending of the blade 210 and the handle 220 in the longitudinal direction. As the reinforcing part 230 is formed further at the handle rear end surface 224 and the heel 13, thickness-direction bending of the blade 210 is suppressed further in a vertical direction from the cutting edge 11 toward the spine 12, which is a direction vertical to the longitudinal direction. While the reinforcing part 230 is made of metal different from the metal forming the blade 210, it may be made of the same metal. Preferably, the reinforcing part 230 has a thickness of equal to or greater than 3.0 mm, which is three times the thickness of the blade 210.

The kitchen knife 200 described above realizes a configuration that can suppress not only bending of the blade 210 but also bending of the handle 220. Thus, this configuration achieves higher usability and is easier to use in cutting food materials.

Even if the blade 210 and the handle 220 are not formed integrally but are formed separately, the reinforcing part 230 can still be configured to extend to the handle 220. Additionally, the reinforcing part 230 is not always required to be formed continuously as far as to the heel 13. Even if the reinforcing part 230 is formed to an intermediate position of any of the handle upper end surface 225, the handle rear end surface 224, the handle lower end surface 226, and the heel 13, or formed on parts of these members, the reinforcing part 230 still achieves the effect of suppressing bending of the blade 210 and the handle 220 to a certain degree.

### Third Embodiment

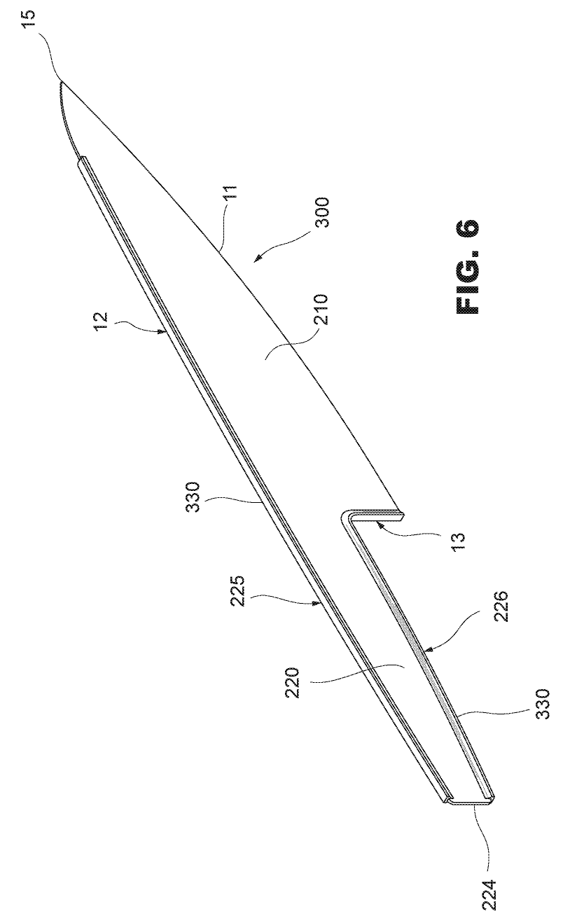

FIG. 6 is a perspective view showing a kitchen knife 300 according to a third embodiment. In the present embodiment, the parts different from that of the second embodiment will be described mainly and description of a part corresponding to that of the second embodiment may be omitted. A sectional view of the kitchen knife 300 is the same as that shown in FIG. 5 according to the second embodiment.

As shown in FIG. 6, the kitchen knife 300 has a configuration including a blade 210, the handle 220, and a reinforcing part 330. In comparison to the kitchen knife 200 of the second embodiment, in the kitchen knife 300, the area where the reinforcing part 330 is formed is partially different.

More specifically, the reinforcing part 330 for reinforcing the blade 210 and the handle 220 in the thickness direction is provided in such a manner as to extend along the spine 12, the handle upper end surface 225, the handle lower end surface 226, and the heel 13. Namely, unlike in the kitchen knife 200 of the second embodiment, the reinforcing part 330 is not provided at the handle rear end surface 224. Thus, the reinforcing part 330 is divided at the handle rear end surface 224 and is not configured to extend continuously as a whole. The reinforcing part 330 has a U-shaped section.

While the reinforcing part 330 is welded to the blade 210 and the handle 220 by metal inert gas (MIG) welding or tungsten inert gas (TIG) welding, for example, it may be welded by a different method. This also applies to the other embodiments.

Even if the kitchen knife 300 to be used has the above-described configuration, this configuration still makes it possible to suppress bending of the blade 210 and the handle 220. Thus, this configuration achieves higher usability and is easier to use in cutting food materials.

### Fourth Embodiment

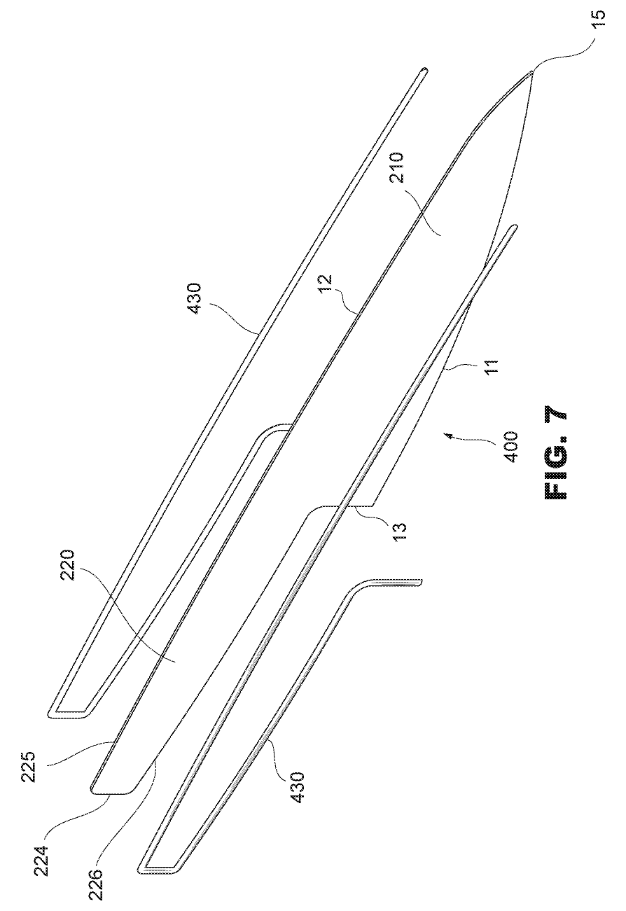

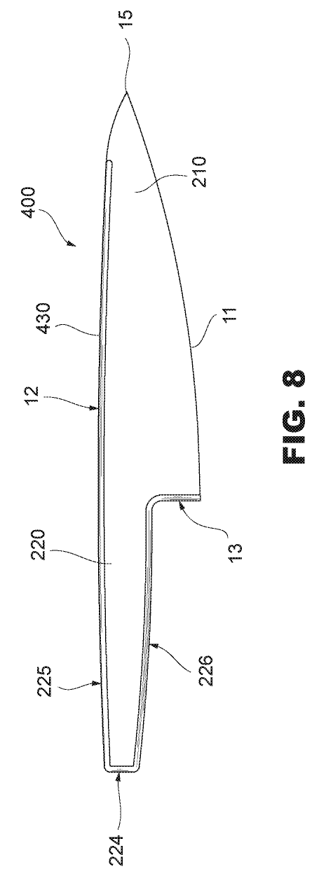

FIGS. 7 and 8 show a kitchen knife 400 according to a fourth embodiment. FIG. 7 is an exploded perspective view. FIG. 8 is a front view. In the present embodiment, the parts different from that of the second embodiment will be described mainly and description of a part corresponding to that of the second embodiment may be omitted.

As shown in FIG. 7, the kitchen knife 400 has a configuration including the blade 210, the handle 220, and a reinforcing part 430. In comparison to the kitchen knife 200 of the second embodiment, the reinforcing part 430 has a different configuration in the kitchen knife 400 of the present embodiment.

More specifically, like the reinforcing part 230 of the second embodiment, the reinforcing part 430 for reinforcing the blade 210 and the handle 220 in the thickness direction is provided in such a manner as to extend along the spine 12, the handle upper end surface 225, the handle rear end surface 224, the handle lower end surface 226, and the heel 13. However, the reinforcing part 430 is not formed using a member having a U-shaped section but is made of metal that is shaped by welding in such a manner as to hold the blade 210 and the handle 220 therein. While the reinforcing part 430 is made of metal different from the metal forming the blade 210, it may be made of the same metal.

In the exploded perspective view of FIG. 7, for the purpose of convenience, the reinforcing part 430 is illustrated as being divided into two in such a manner as to interpose the blade 210 and the handle 220 therebetween. However, the reinforcing part 430 is the metal welded to the blade 210 and the handle 220 and is actually joined to these parts.

### Fifth Embodiment

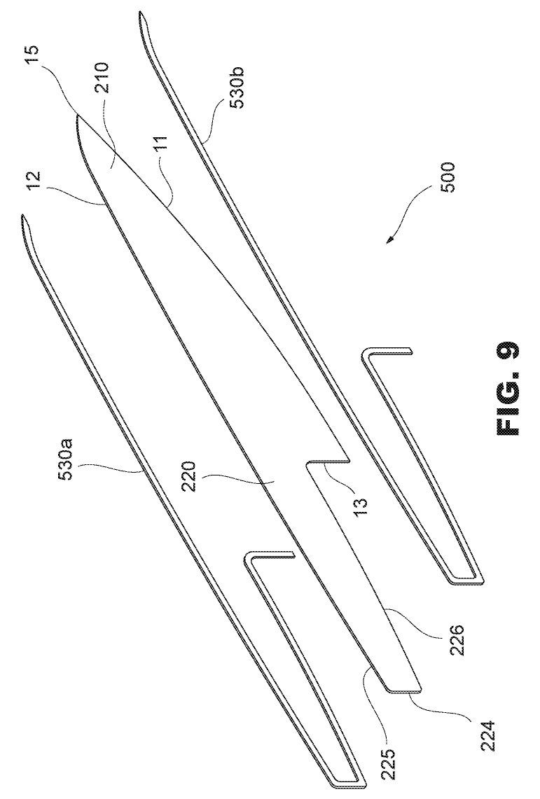

FIGS. 9 is an exploded perspective view showing a kitchen knife 500 according to a fifth embodiment. In the present embodiment, the parts different from that of the fourth embodiment will be described mainly and description of a part corresponding to that of the fourth embodiment may be omitted.

As shown in FIG. 9, the kitchen knife 500 has a configuration including the blade 210, the handle 220, and a reinforcing part 530a and a reinforcing part 530b. In comparison to the kitchen knife 400 of the fourth embodiment, the reinforcing parts 530a and 530b have different configurations in the kitchen knife 500 of the present embodiment.

More specifically, the configurations of the reinforcing parts 530a and 530b for reinforcing the blade 210 and the handle 220 in the thickness direction differ from that of the reinforcing part 430 of the fourth embodiment in that the reinforcing parts 530a and 530b as two plate-like members are arranged in such a manner as to interpose the blade 210 and the handle 220 therebetween, and the reinforcing parts 530a and 530b are each joined to the blade 210 and the handle 220 by welding. While the reinforcing parts 530a and 530b are made of metal different from the metal forming the blade 210, they may be made of the same metal.

### Sixth Embodiment

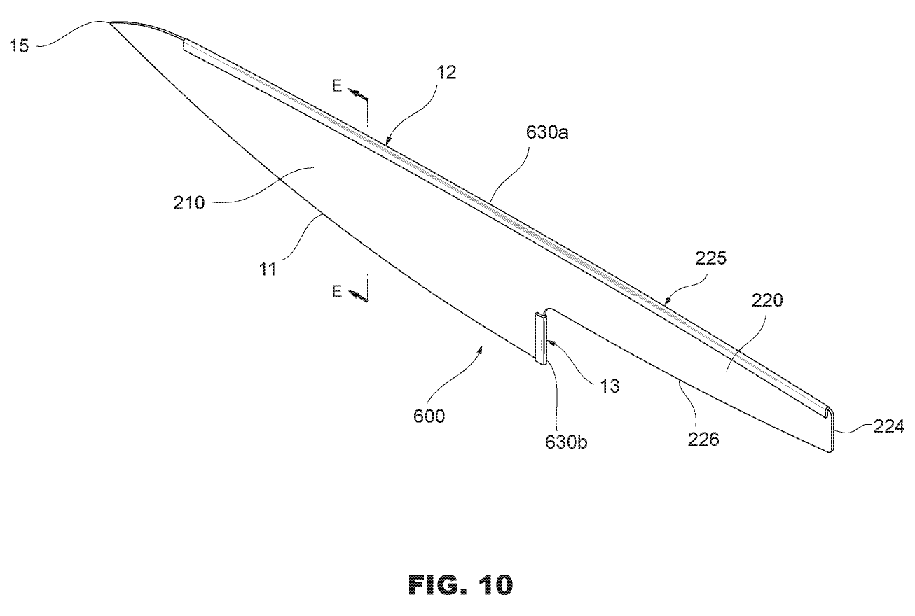

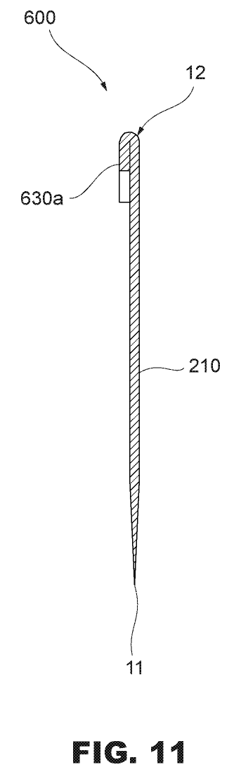

FIGS. 10 and 11 show a kitchen knife 600 according to a sixth embodiment. FIG. 10 is a perspective view. FIG. 11 is a sectional view taken along a position E-E in FIG. 10. In the present embodiment, the parts different from that of the second embodiment will be described mainly and description of a part corresponding to that of the second embodiment may be omitted.

As shown in FIG. 10, the kitchen knife 600 has a configuration including the blade 210, the handle 220, and a reinforcing part 630a and a reinforcing part 630b. In comparison to the kitchen knife 200 of the second embodiment, the reinforcing parts 630a and 630b in the kitchen knife 600 of the present embodiment differ from the reinforcing part 230 of the second embodiment.

More specifically, the reinforcing part 630a is provided in such a manner as to extend along the spine 12 of the blade 210 and the handle upper end surface 225, the reinforcing part 630b is provided in such a manner as to extend along the heel 13, and the reinforcing parts 630a and 630b each reinforces the blade 210 and the handle 220 in the thickness direction. Specifically, the reinforcing part 630a suppresses thickness-direction bending of the blade 210 and the handle 220 in the longitudinal direction, and the reinforcing part 630b suppresses thickness-direction bending of the blade 210 in the vertical direction from the cutting edge 11 toward the spine 12 of the blade 210.

As shown in the sectional view of FIG. 11, the reinforcing parts 630a and 630b are both formed by bending end surfaces of the blade 210 and the handle 220. Specifically, the kitchen knife 600 of the present embodiment is formed integrally as a whole and a joining method such as welding is not used. However, the reinforcing parts 630a and 630b may be welded to further reinforce the reinforcing parts 630a and 630b.

### Seventh Embodiment

In a seventh embodiment, an example of a method of manufacturing a kitchen knife including a reinforcing part that reinforces a blade in a thickness direction and a kitchen knife manufactured by this method will be described in detail.

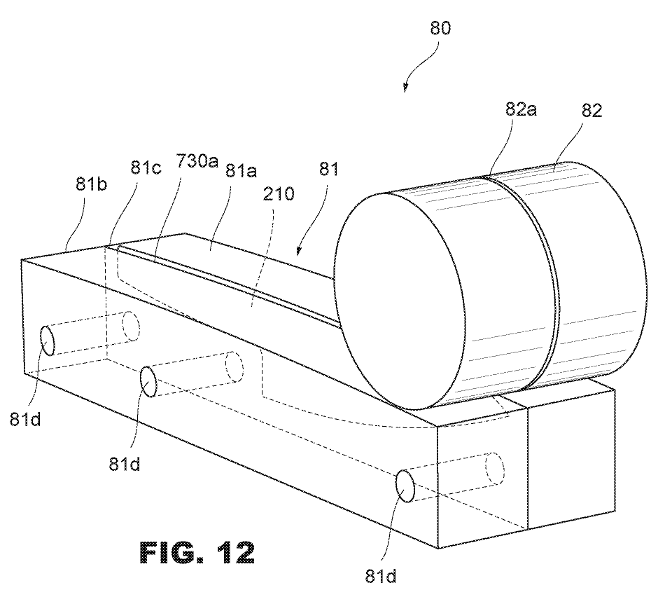

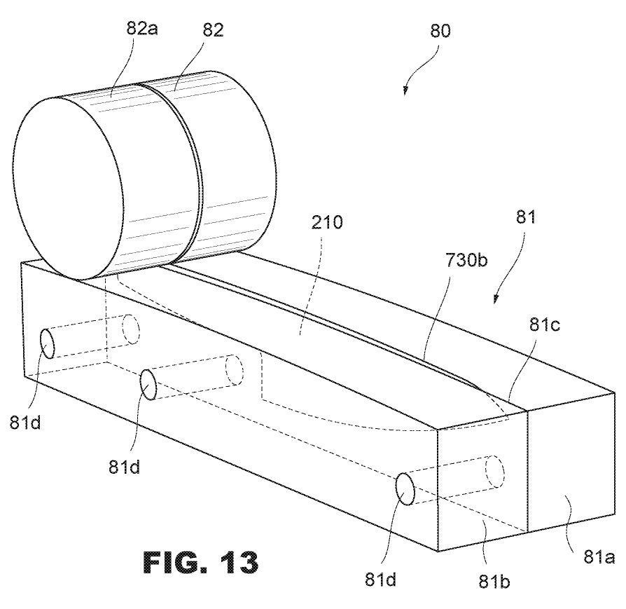

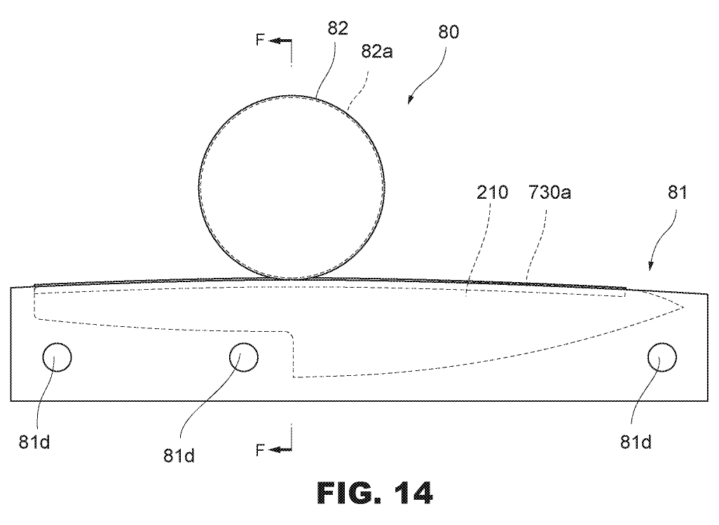

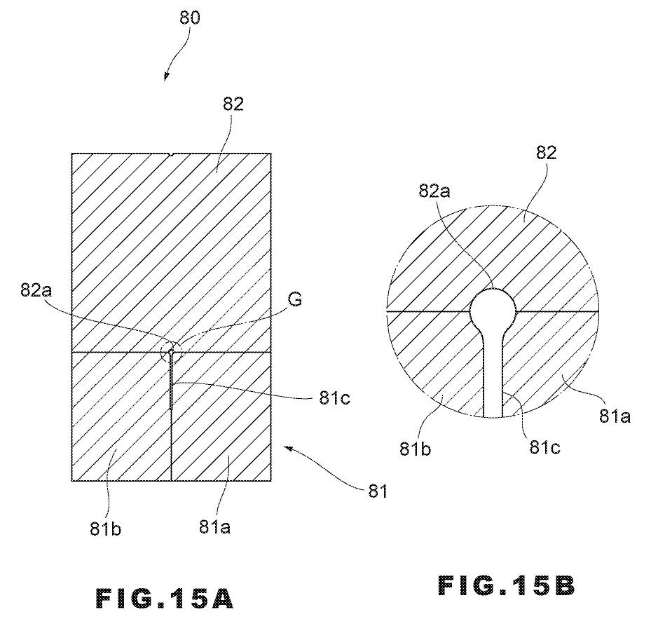

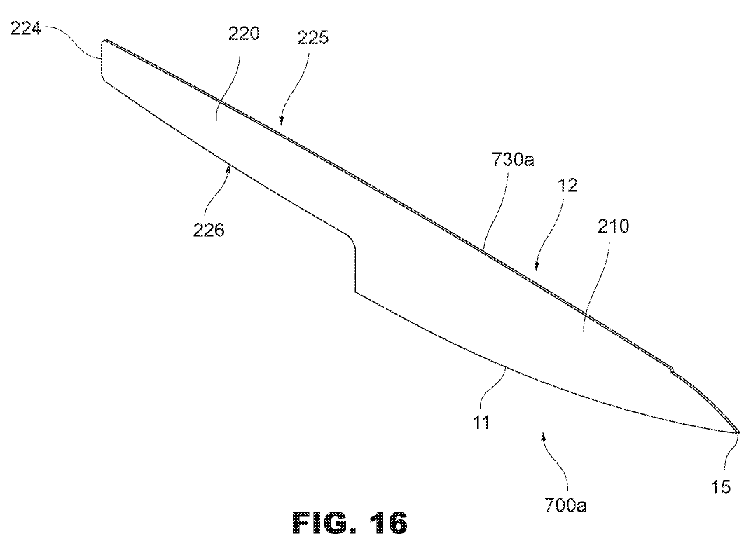

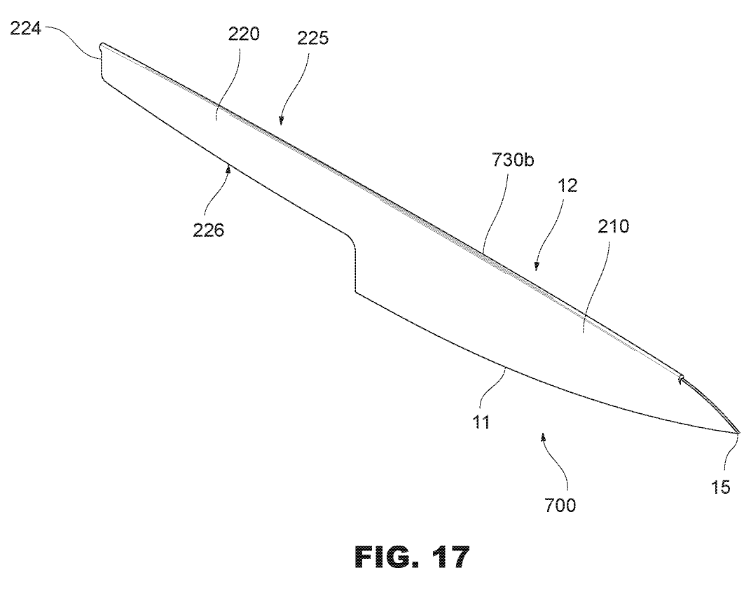

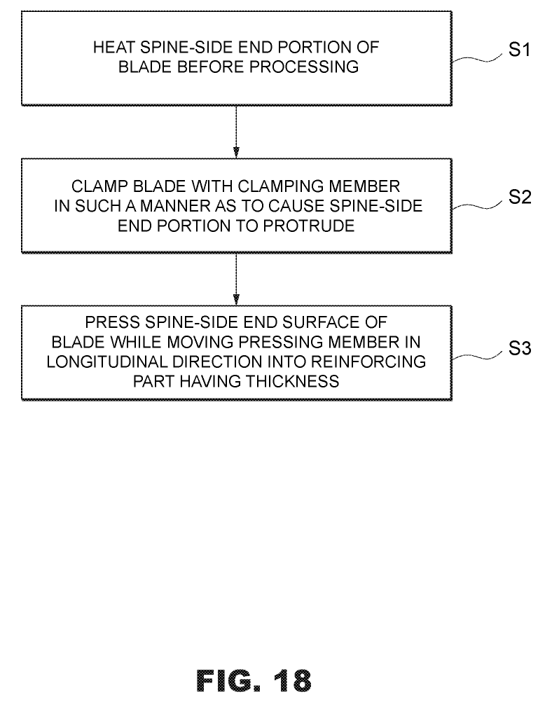

FIGS. 12 to 18 show a kitchen knife 700 and a method of manufacturing the kitchen knife 700 according to the seventh embodiment. FIGS. 12 to 15A, 15B show a processing unit. FIG. 12 is a perspective view showing a state before processing. FIG. 13 is a perspective view showing a state after the processing. FIG. 14 is a front view. FIG. 15A is a sectional view taken along a position F-F in FIG. 14. FIG. 15B is an enlarged view of an area G in FIG. 15A. FIGS. 16 and 17 show the kitchen knife 700. FIG. 16 shows a state before the processing. FIG. 17 shows a state after the processing. FIG. 18 is a flowchart showing a flow of the processing according to the present embodiment.

As shown in FIG. 16, a blade before processing (blank blade) 700a as a processing target has a configuration including a blade 210, a handle 220, and a spine-side end portion 730a. The spine-side end portion 730a is provided at an end portion of the blade 210 on a spine side and is formed with a step height in such a manner as to protrude from the spine side of the blade 210 (see FIG. 16). The spine-side end portion 730a is formed on the spine side of the blade 700a before processing from a handle rear end surface 224 to a position closer to a rear end than a point 15 and on a slightly near side relative to the point 15. The spine-side end portion 730a is formed from the handle rear end surface 224 to a position closer to the rear end than the point by an interval equal to or greater than 10 mm and equal to or less than 50 mm. The spine-side end portion 730a is curved into a shape with a protrusion at a center in a longitudinal direction.

As shown in FIGS. 12 to 15A, a processing unit 80 includes a clamping die 81 and a pressing roller die 82. The clamping die 81 is an example of a “clamping member” of the present disclosure. The pressing roller die 82 is an example of a “pressing member” of the present disclosure.

The clamping die 81 includes a clamping die piece 81a and a clamping die piece 81b. The clamping die pieces 81a and 81b can clamp the blade 210 as a processing target from both sides. Like the curved shape of the spine-side end portion 730a, the clamping die 81 is curved into a shape with a protrusion at a center in a longitudinal direction. The clamping die piece 81b has a through hole 81d penetrating the clamping die piece 81b in a thickness direction.

The pressing roller die 82 has a circular columnar shape, and has a groove 82a formed at a center position of the circular column in a height direction in such a manner as to circle the pressing roller die 82 along a side surface thereof.

As shown in the sectional view of FIG. 15A and FIG. 15B as an enlarged view of FIG. 15A, the clamping die 81 has a clearance 81c formed at a position where the clamping die pieces 81a and 81b face each other and having a predetermined thickness in an abutting direction, specifically, in a thickness direction of the blade 700a before processing to be clamped. The clearance 81c extends in the longitudinal direction of the clamping die 81. In processing the blade 700a before processing, the groove 82a of the pressing roller die 82 is located in such a manner as to face the clearance 81c to form space together with the clearance 81c in which the spine-side end portion 730a is to be processed into a reinforcing part 730b.

### Processing for Reinforcing Part Formation

As shown in the flowchart of FIG. 18, in processing the spine-side end portion 730a into the reinforcing part 730b, the spine-side end portion 730a of the blade 700a before processing is first induction heated to provide a shape in an easy-to-process flexible state (S1).

Next, the blade 700a before processing is clamped by the clamping die 81 in such a manner that the spine-side end portion 730a protrudes from the clamping die 81 (S2).

Next, the spine-side end portion 730a protruding from the clamping die 81 is pressed while the pressing roller die 82 is moved by being rotated from one side (position shown in FIG. 12) to the other side (position shown in FIG. 13) in the longitudinal direction. By doing so, the spine-side end portion 730a is forged into the reinforcing part 730b having a thickness relative to the other part of the blade 210 (S3).

At this time, the space formed by the clearance 81c of the clamping die 81 and the groove 82a of the pressing roller die 82 maintains the section shown in FIGS. 15A and 15B, thereby forming the reinforcing part 730b having a similar shape in the longitudinal direction of the blade 210. The above-descried forging may be performed several times so as to press the spine-side end portion 730a sufficiently into the shape of the space formed by the clearance 81c of the clamping die 81 and the groove 82a of the pressing roller die 82.

As a result of the above-described processing, it is possible to form a kitchen knife with the reinforcing part 730b provided on the spine side of the blade 210. Furthermore, as the spine-side end portion 730a is forged by applying heat, it is possible to form the reinforcing part 730b with high rigidity.

The heating of the spine-side end portion 730a is not limited to induction heating but may be heating using different process. Moreover, instead of heating the spine-side end portion 730a before the processing, the spine-side end portion 730a may be heated during the processing.

The spine-side end portion 730a is not always required to have the curved shape in the longitudinal direction. Preferably, the clamping die 81 has a shape corresponding to that of the spine-side end portion 730a.

### Modifications

Each of the above-described embodiments is merely an example of the present disclosure and is not intended to limit interpretation of the technical scope of the present disclosure. Each constituting element, arrangement, material, shape, size, etc. provided in each of the embodiments are not limited to those shown as examples in the embodiments but are changeable within a range not deviating from the purport of the disclosure. Moreover, some of the configurations shown in the respective embodiments may be combined or replaced.

While some specific examples of the reinforcing part for reinforcing the blade and the handle in the thickness direction to suppress bending occurring at the blade and the handle have been given in the embodiments, the reinforcing part is not limited to these examples. For example, the kitchen knife may have a configuration where the reinforcing part is provided only at the spine of the blade and the handle upper end surface or a configuration where the reinforcing part is provided only at the spine of the blade and the handle lower end surface. Alternatively, the kitchen knife may have a configuration where the reinforcing part is provided only at a part of the spine of the blade. This configuration still achieves the effect of suppressing bending of the blade to a certain degree.

In the configuration including the blade 210 and the handle 220 shown in the embodiments, the reinforcing part may be configured to be present only at the spine 12 of the blade 210.

Methods of forming the reinforcing part described in the embodiments are not limited to those of the embodiments but various types of methods can be employed. For example, an elongated rod-like or plate-like member extending along a spine-side end portion to be processed into a reinforcing part may be placed on this spine-side end portion and the spine-side end portion may be bent along with this member or this member may be wrapped on the spine-side end portion, thereby forming the reinforcing part having a thickness.

What is claimed is:

1. A kitchen knife comprising:
a blade with a cutting edge at a first end surface on a first side of the blade; and
a reinforcing part provided in such a manner as to extend along a spine that is at a second end surface of the blade on a second side of the blade opposing the first side, and configured to reinforce the blade in a thickness direction,
wherein the reinforcing part is made of a metallic member and joined to the spine, and
wherein the reinforcing part is provided in such a manner as to extend continuously from the spine to a grasped part to be grasped by a user.

2. The kitchen knife according to claim 1, wherein the metallic member is different from a metal forming the blade.

3. The kitchen knife according to claim 1, wherein the reinforcing part is provided in such a manner as to extend along an end surface of the grasped part and to extend continuously to a heel that is a third end surface of the blade adjacent to the grasped part.

4. The kitchen knife according to claim 1, wherein the reinforcing part is provided in such a manner as to extend further along an end surface of the grasped part on the first side of the blade.

5. The kitchen knife according to claim 1, wherein the blade has a blade length of equal to or greater than 100 mm.

6. The kitchen knife according to claim 1, wherein the blade is made of metal having a thickness of equal to or less than 2.5 mm.

7. The kitchen knife according to claim 1, wherein the spine including the reinforcing part has a thickness in the thickness direction that is three times or more than a thickness of the blade at a thickest position.

8. The kitchen knife according to claim 1, wherein the blade has a weight of equal to or less than 200 g.
